(19) United States
(12) Patent Application Publication
(10) Pub. No.: US 2015/0357083 A1
(43) Pub. Date: Dec. 10, 2015

(54) CABLE STRUCTURES WITH MULTI-MATERIAL EXTRUDED STRAIN RELIEFS AND SYSTEMS AND METHODS FOR MAKING THE SAME

(71) Applicant: Apple Inc., Cupertino, CA (US)

(72) Inventors: Christopher S. Graham, Cupertino, CA (US); Eric S. Jol, San Jose, CA (US); Joseph I. Briskey, Aptos, CA (US); Timothy J. Rasmussen, Cupertino, CA (US); Albert J. Golko, Saratoga, CA (US)

(21) Appl. No.: 14/501,784

(22) Filed: Sep. 30, 2014

Related U.S. Application Data
(60) Provisional application No. 62/010,085, filed on Jun. 10, 2014.

(51) Int. Cl. H01B 7/18; H01B 13/14; H01B 7/02

(52) U.S. Cl. CPC H01B 7/18; H01B 7/0275; H01B 13/141

(57) ABSTRACT

Cable structures with multi-material extruded strain reliefs and systems and methods for making the same are provided. In some embodiments, a cable structure may include at least two materials simultaneously extruded through a die and about a conductor. A relationship between the two materials may be changed during the simultaneous extrusion for varying the stiffness of the cable structure, which may thereby provide a strain relief region to the cable structure. One of the two materials may be stiffer than another of the two materials, and the ratio of the amount or thickness of one of the two materials with respect to the amount or thickness of the other of the two materials may be varied during the extrusion process to vary the stiffness of the cable structure along its length for providing the strain relief region.

### CROSS-REFERENCE TO RELATED APPLICATION(S)

This application claims the benefit of prior filed U.S. Provisional Patent Application No. 62/010,085, filed Jun. 10, 2014, which is hereby incorporated by reference herein in its entirety.

### TECHNICAL FIELD

This disclosure relates to cable structures and, more particularly, to cable structures with multi-material extruded strain reliefs and systems and methods for making the same.

### BACKGROUND OF THE DISCLOSURE

A conventional cable structure used for data and/or power signal transmission typically includes at least one conductor extending along a length of the cable structure and a cover surrounding the conductor along at least a portion of the length of the cable structure. Often times, a strain relief component is positioned over a portion of the cover or adjacent to an end of the cover to dampen strains on the cable structure. However, such a strain relief component is often too large and/or too visually distinct from the remainder of the cable structure for desired cosmetic properties of the cable structure. Accordingly, alternative strain reliefs for cable structures are needed.

### SUMMARY OF THE DISCLOSURE

This document describes cable structures with multi-material extruded strain reliefs and systems and methods for making the same.

For example, in some embodiments, there is provided a method for forming a cable structure that may include simultaneously extruding a first material through a first opening of a die and a second material through a second opening of the die about the first material. The method may also include, during the extruding, changing a relationship between the first material and the second material.

In other embodiments, there is provided a cable structure that may include a conductor arrangement extending along a length of the cable structure and a cover that may include a first cover material surrounding the conductor arrangement along the length of the cable structure and a second cover material surrounding the first cover material along the length of the cable structure. A relationship between the first cover material and the second cover material may vary along the length of the cable structure.

In yet other embodiments, there is provided a method for forming a cable structure that may include providing a first material from a barrel of a first extruder subsystem of an extruder system to a die of the extruder system, providing a second material from a barrel of a second extruder subsystem of the extruder system to the die, simultaneously extruding the provided first material and the provided second material through the die and about a conductor, and, during the extruding, changing a relationship between the simultaneously extruded first and second materials, where the changing may create a strain relief for the cable structure.

This Summary is provided merely to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a perspective view of an illustrative assembly that includes at least one cable structure with a strain relief;

FIG. 2 is a cross-sectional view of an illustrative system that may be used to manufacture at least a portion of a cable structure of FIG. 1;

FIG. 2A is a cross-sectional view of another illustrative system that may be used to manufacture at least a portion of a cable structure of FIG. 1;

FIG. 3 is a cross-sectional view of a portion of a cable structure of FIG. 1, taken from line of FIG. 1;

FIG. 3A is a cross-sectional view of the cable structure of FIGS. 1 and 3, taken from line IIIA-IIIA of FIG. 3;

FIG. 4 is a cross-sectional view of a portion of a cable structure of FIG. 1, taken from line IV-IV of FIG. 1;

FIG. 4A is a cross-sectional view of the cable structure of FIGS. 1 and 4, taken from line IVA-IVA of FIG. 4;

FIG. 5 is a cross-sectional view of a portion of a cable structure of FIG. 1, taken from line V-V of FIG. 1;

FIG. 5A is a cross-sectional view of the cable structure of FIGS. 1 and 5, taken from line VA-VA of FIG. 5;

FIG. 6 is a graph showing illustrative characteristics of a process for manufacturing at least a portion of a cable structure of FIG. 1 using the system of FIG. 2 or FIG. 2A; and

FIGS. 7 and 8 are flowcharts of illustrative processes for manufacturing a cable structure.

### DETAILED DESCRIPTION OF THE DISCLOSURE

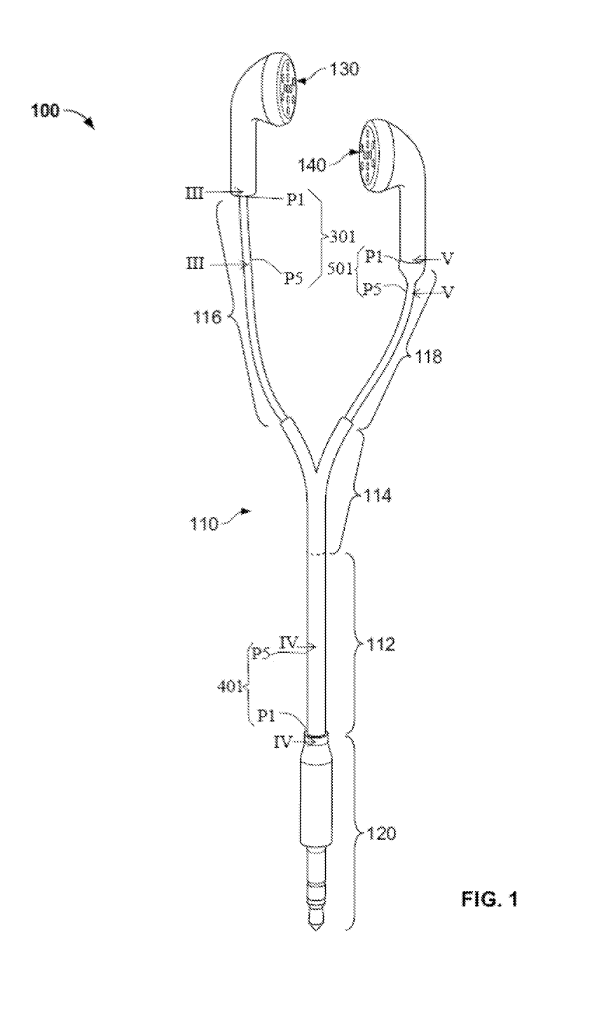

Cable structures with multi-material extruded strain reliefs and systems and methods for making the same are provided and described with reference to FIGS. 1-8.

A cable structure can include at least two materials simultaneously extruded through a die and about a conductor. A relationship between the two materials may be changed during the simultaneous extrusion for varying the stiffness of the cable structure, which may thereby provide a strain relief region to the cable structure. In some embodiments, each of the two materials may be extruded through its own die opening of the die, where a first of the two materials may be extruded about the conductor, and where a second of the two materials may be extruded about the first material. In other embodiments, the two materials may be mixed together and the mixture may be extruded through a single die opening of the die about the conductor. One of the two materials may be stiffer than another of the two materials, and the ratio of the amount or thickness of one of the two materials with respect to the amount or thickness of the other of the two materials may be varied during the extrusion process to vary the stiffness of the cable structure along its length for providing the strain relief region. The outer diameter of the cable structure may be constant along its strain relief region and/or along the entirety of the cable structure for providing an aesthetically pleasing cable structure. Additionally or alternatively, the appearance (e.g., color, texture, etc.) of the outermost extruded material may be constant along the strain relief region and/or along the entirety of the cable structure for providing an aesthetically pleasing cable structure. Varying the amount of a stiffer material with respect to a less stiff material used to form a cable structure cover during a single manufacture process (e.g., a single extrusion process) may enable the cover to have a seamless look and feel while also reducing the number of manufacture processes required to create the cable structure.

A cable structure including at least one multi-material extruded strain relief may be provided as part of any suitable cabled assembly that may include at least one conductor configured to transmit data and/or power signals between at least two ends of the assembly, each of which may include a cable connector or any other suitable termination point. Such a cabled assembly may include, but is not limited to, a cabled headset assembly, a cabled power adaptor assembly, a cabled microphone assembly, and the like. For example, as shown in FIG. 1, a cabled headset assembly 100 may include a cable 110 that can electrically couple two or more non-cable components of assembly 100 (e.g., cable 110 may electrically couple an audio connector 120 to a left speaker 130 and/or a right speaker 140 of assembly 100). Cable 110 may include a main cable structure 112 that may extend between audio connector 120 and a bifurcation cable structure (e.g., forked structure) 114 of cable 110. Cable 110 may also include a left cable structure 116 that may extend between bifurcation cable structure 114 and left speaker 130. Alternatively or additionally, cable 110 may include a right cable structure 118 that may extend between bifurcation cable structure 114 and right speaker 140. Any one or more of cable regions 112, 114, 116, and 118 of cable 110 may include at least one multi-material extruded strain relief about at least one conductor that may be configured to transmit data and/or power signals between audio connector 120 and one or both of left speaker 130 and right speaker 140.

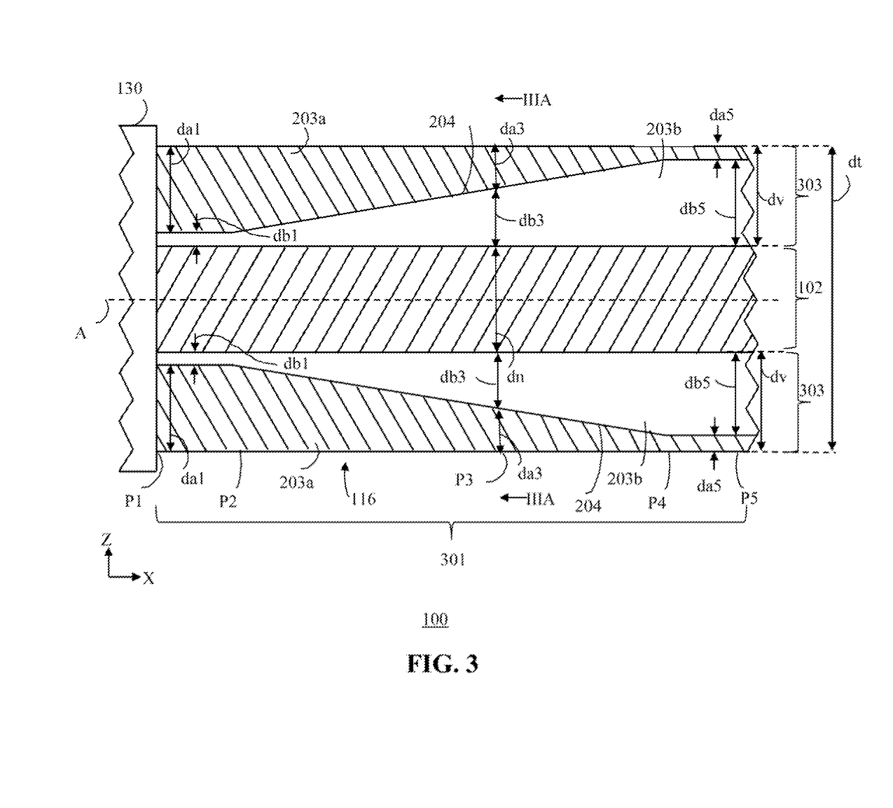

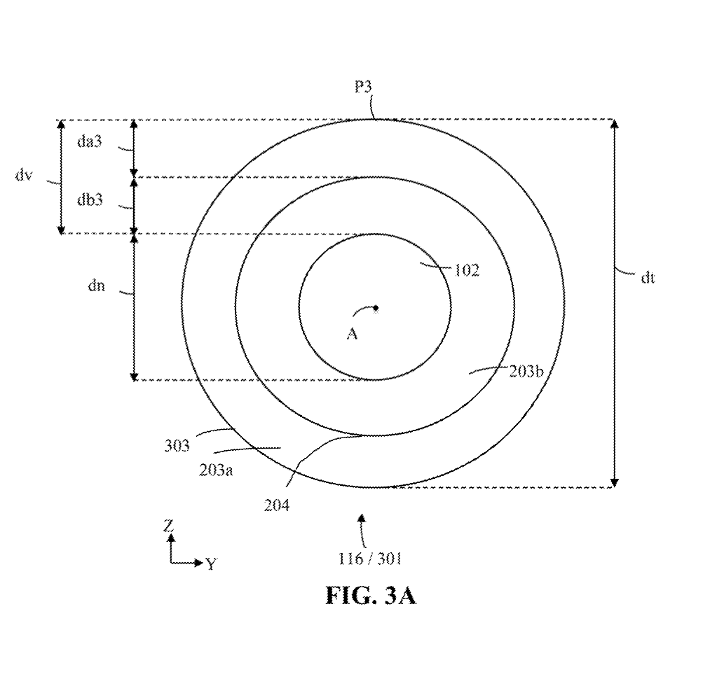

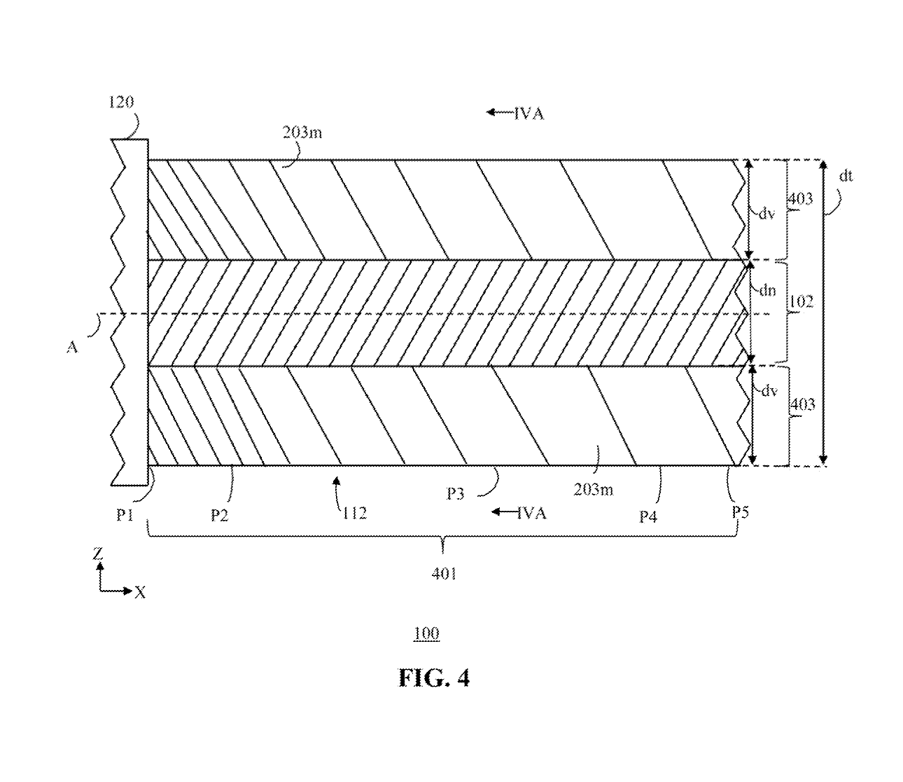

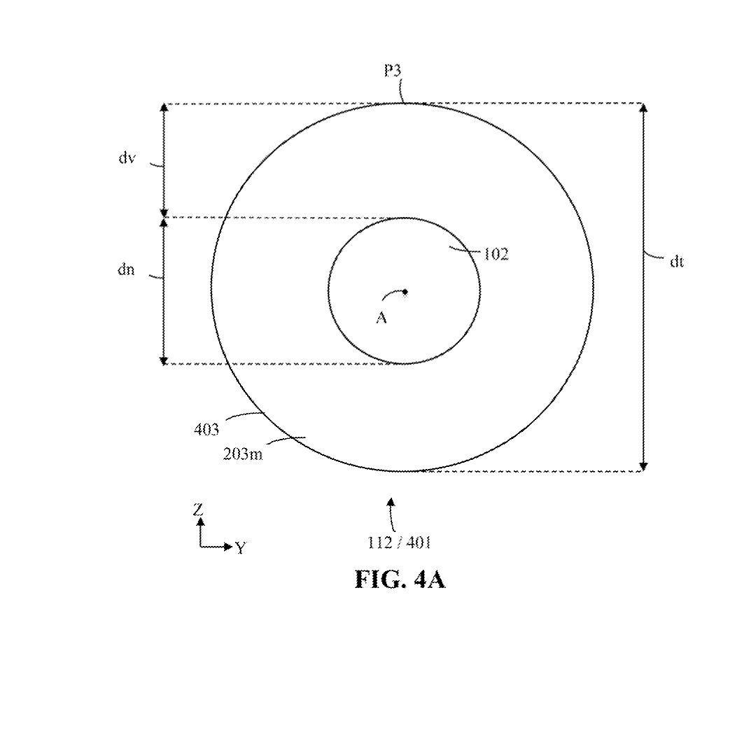

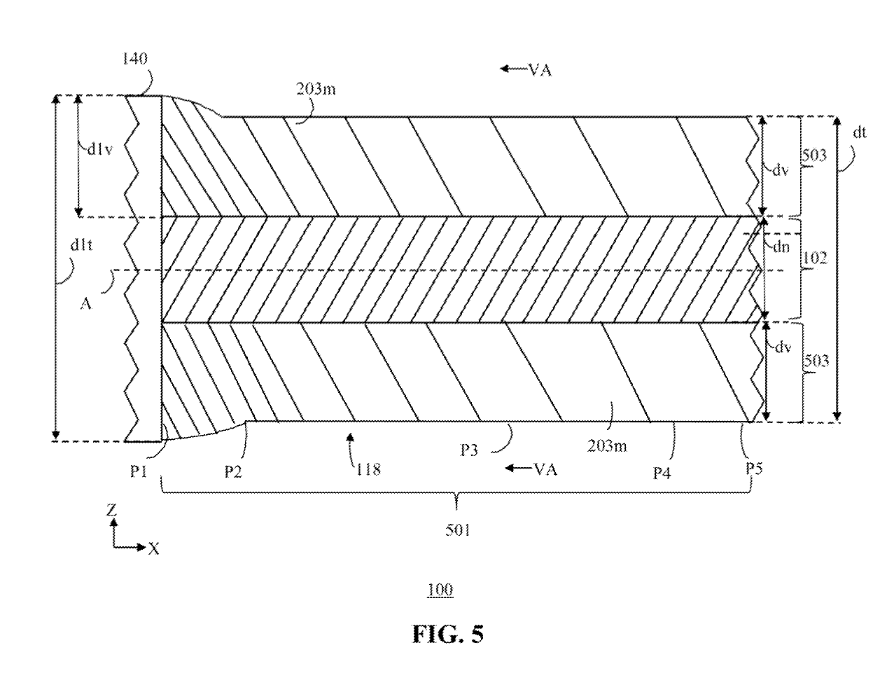

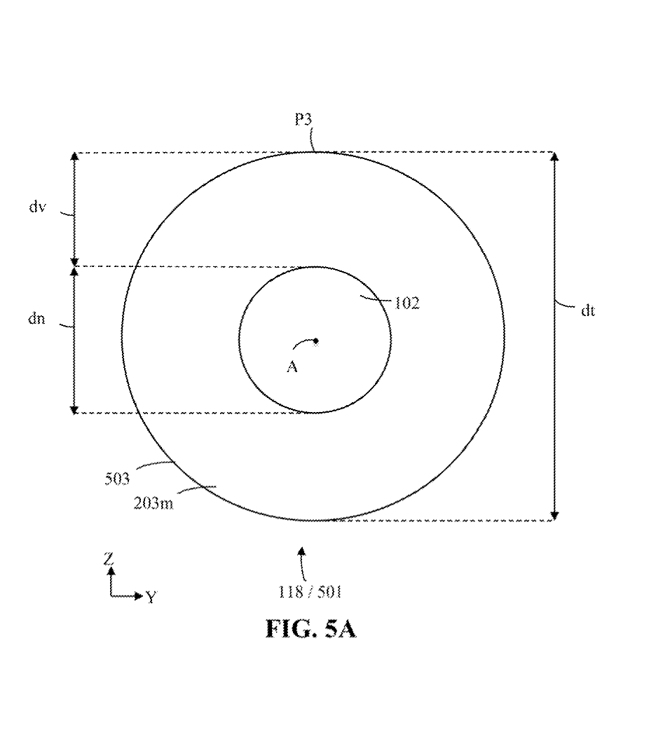

A conductor arrangement may include one or more conductors that may extend through each one of cable structures 112, 114, 116, and 118, and may be configured to communicate data and/or power signals between audio connector 120, left speaker 130, and right speaker 140. Moreover, each one of cable structures 112, 114, 116, and 118 may include a cover that may surround its conductor arrangement along at least a portion of the length of the cable structure. For example, as shown in FIGS. 1, 3, and 3A, left cable structure 116 may include a conductor arrangement 102 extending along a length of left cable structure 116 (e.g., along a longitudinal axis A of left cable structure 116) and a cover 303 that may surround conductor arrangement 102 along at least a portion of the length of left cable structure 116 (e.g., along longitudinal axis A). Such a cover 303 may provide protection for its conductor arrangement 102 (e.g., insulation and/or shielding) and may, in some embodiments, provide an outer surface of left cable structure 116. In other embodiments, an additional cosmetic layer may be positioned about the outer surface of cover 303 for providing the outermost surface of left cable structure 116. As another example, as shown in FIGS. 1, 4, and 4A, main cable structure 112 may include a conductor arrangement 102 extending along a length of main cable structure 112 (e.g., along a longitudinal axis A of main cable structure 112) and a cover 403 that may surround conductor arrangement 102 along at least a portion of the length of main cable structure 112. Such a cover 403 may provide protection for its conductor arrangement 102 and may, in some embodiments, provide an outer surface of main cable structure 112. In other embodiments, an additional cosmetic layer may be positioned about the outer surface of cover 403 for providing the outermost surface of main cable structure 112. As yet another example, as shown in FIGS. 1, 5, and 5A, right cable structure 118 may include a conductor arrangement 102 extending along a length of right cable structure 118 (e.g., along a longitudinal axis A of right cable structure 118) and a cover 503 that may surround conductor arrangement 102 along at least a portion of the length of right cable structure 118. Such a cover 503 may provide protection for its conductor arrangement 102 and may, in some embodiments, provide an outer surface of right cable structure 118. In other embodiments, an additional cosmetic layer may be positioned about the outer surface of cover 503 for providing the outermost surface of right cable structure 118.

Any one or more of cable structures 112, 114, 116, and 118 may include at least one multi-material extruded strain relief region, which may provide strain relief to dampen strains on cable 110. In some embodiments, such a strain relief region may be incorporated into a cover of the cable structure. Such a strain relief region may include two or more distinct materials with different properties (e.g., different elastic modulus, stiffness, durometer, hardness, flexibility, etc.) that may be extruded simultaneously to form a single cross-section of the cover, whereby a portion of a strain relief region of the cover may include a greater ratio of a stiffer first material to a less-stiff second material than a non-strain relief region of the cover. Thus, in some embodiments, such a strain relief region may better enable the cable structure to withstand bend stresses. For example, as shown in FIGS. 1, 3, and 3A, left cable structure 116 may include a first strain relief region 301 at an end portion of cover 303 of left cable structure 116 that may be adjacent to left speaker 130 (e.g., strain relief region 301 may extend from a point P1 adjacent left speaker 130 to a point P5 at a certain distance along the length of cover 303 of left cable structure 116 away from left speaker 130), where strain relief region 301 of cover 303 may include extruded material 203a and extruded material 203b. Additionally or alternatively, as shown in FIGS. 1, 4, and 4A, main cable structure 112 may include a second strain relief region 401 at an end portion of cover 403 of main cable structure 112 that may be adjacent to audio connector 120 (e.g., strain relief region 401 may extend from a point P1 adjacent audio connector 120 to a point P5 at a certain distance along the length of cover 403 of main cable structure 112 away from audio connector 120), where strain relief region 401 of cover 403 may include extruded material 203a and extruded material 203b. Additionally or alternatively, as shown in FIGS. 1, 5, and 5A, right cable structure 118 may include a third strain relief region 501 at an end portion of cover 503 of right cable structure 118 that may be adjacent to right speaker 140 (e.g., strain relief region 501 may extend from a point P1 adjacent right speaker 140 to a point P5 at a certain distance along the length of cover 503 of right cable structure 118 away from right speaker 140), where strain relief region 501 of cover 503 may include extruded material 203a and extruded material 203b.

A cable structure including at least one strain relief region (e.g., any one of cable structures 112, 114, 116, and 118 of FIG. 1) can be constructed using any suitable manufacturing process or combination of manufacturing processes. For example, in some embodiments, a cable structure including at least one strain relief region can be at least partially constructed via an extrusion process, and such an extrusion process may include one or more controllable system factors for adjusting one or more characteristics of a strain relief region. Such an extrusion process may simultaneously extrude at least two different materials for defining the same cross-section of a cable cover, where the two different materials may differ with respect to at least one quality, such as stiffness. A characteristic of at least one of the two materials, such as cross-sectional thickness or mass, may vary during the extrusion process for varying a characteristic of the cover along its length, which may thereby form a strain relief reuion of the cover.

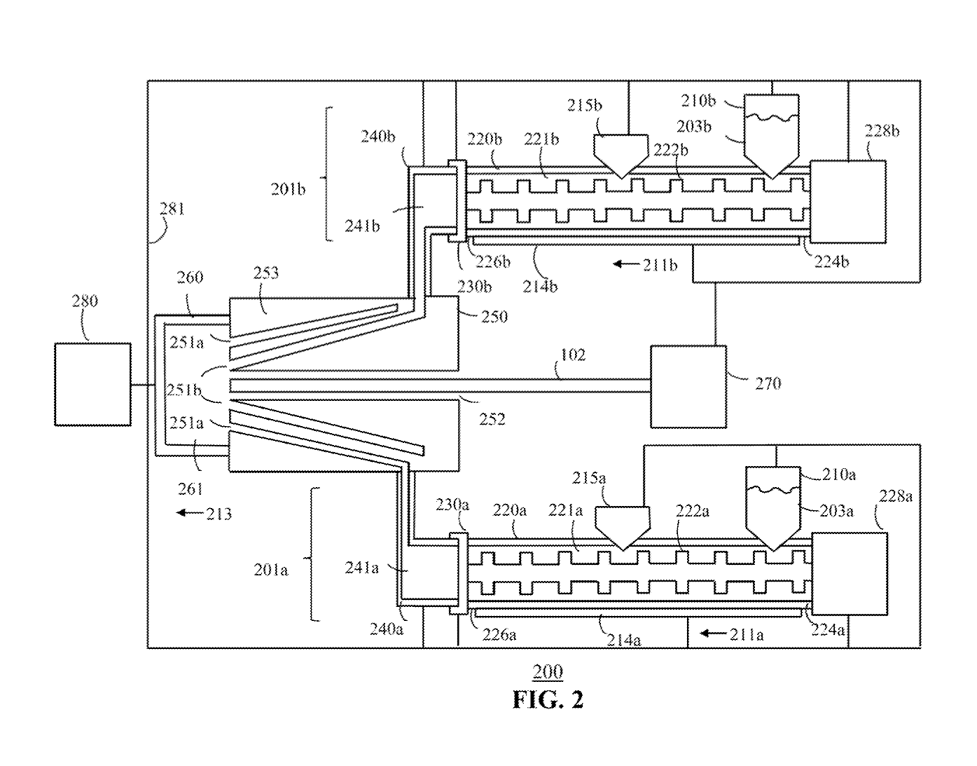

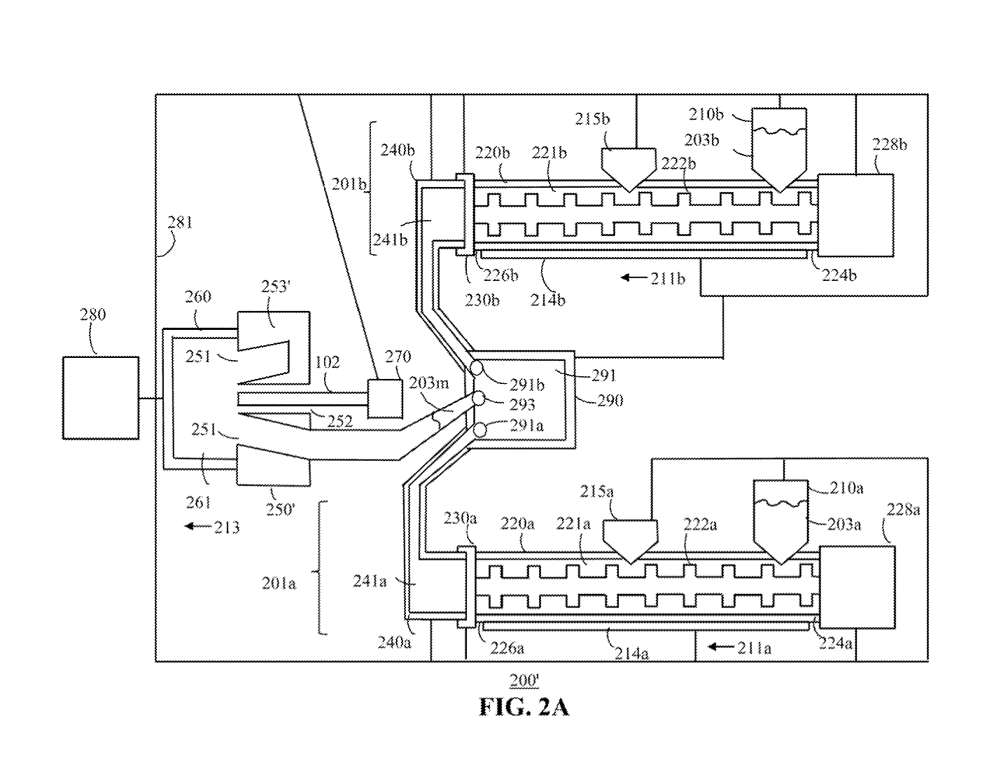

FIG. 2 is a cross-sectional view of an illustrative extruder system 200. Extruder system 200 can include at least two extruder subsystems 201, each of which may feed a different material into a shared cross-head or extrusion die 250. For example, as shown in FIG. 2, extruder system 200 may include at least a first extruder subsystem 201a, which can feed a first base material 203a through a first die opening 251a of die 250, and a second extruder subsystem 201b, which can feed a second base material 203b through a second die opening 251b of die 250. Moreover, as shown in FIG. 2, extruder system 200 can include a line controller 270, which can feed a conductor arrangement 102 through a hypodermal path 252 of die 250. Extruder system 200 can be configured to simultaneously extrude first base material 203a and second base material 203b through die 250 and about conductor arrangement 102 for forming a cover with a strain relief region (e.g., cover 303 with strain relief region 301 that may include both first extruded material 203a and second extruded material 203b about conductor arrangement 102 of FIGS. 3 and 3A), where first die opening 251a may be at least partially exterior to (e.g., annular about) second die opening 251b and where second die opening may be exterior to (e.g., annular about) hypodermal path 252, such that first extruded material 203a may be at least partially exterior to (e.g., annular about) second extruded material 203b and such that second extruded material 203b may be exterior to (e.g., annular about) conductor arrangement 102. It is to be understood that first extruder subsystem 201a and second extruder subsystem 201b may be substantially identical and may include like parts, where reference characters 2XXa that may be shown and/or described with respect to first extruder subsystem 201a may be similar to reference characters 2XXb that may be shown and/or described with respect to second extruder subsystem 201b. Therefore, only one of the extruder subsystems 201 of system 200 may be described in detail herein. However, it is to be understood that first base material 203a of first extruder subsystem 201a and second base material 203b of second extruder subsystem 201b may differ in one or more ways as described below in order to form a strain relief region of a cover. Moreover, it is to be understood that certain controllable system factors of subsystem 201a may be controlled differently than similar certain controllable system factors of subsystem 201b for adjusting one or more characteristics of a strain relief region of a cover.

Each extruder subsystem 201 can receive any suitable base material or combination of base materials to be extruded in a first form, such as pellets, and can transform the base material or combination of base materials to a form corresponding to at least a portion of a cover of one or more of cable structures 112, 114, 116, and 118 of FIG. 1 (e.g., cover 303 of FIGS. 3 and 3A). For example, with specific references to first extruder subsystem 201a, first extruder subsystem 201a can use any suitable base material 203a, which may include, but is not limited to, any suitable thermoplastic polyurethane (“TPU”) (e.g., by BASF), any suitable thermoplastic elastomer (“TPE”) (e.g., by Teknor Apex), any suitable polyethylene, any suitable polypropylene, any suitable acetal, any suitable acrylic, any suitable polyamide (e.g., nylon), any suitable polystyrene, any suitable acrylonitrile butadiene styrene (“ABS”), any suitable fluoropolymer, any suitable polycarbonate, Sabic's flexible NORYL™ and/or PPO™, DuPont's Hytrel TPC-ET, any suitable thermoplastic copolyester elastomers (e.g., DSM's Arnitel CoPE and TPC), any suitable thermoplastic polyurethane (TPE-U) (e.g., PolyOne's ECCOH and OnFlex materials), any suitable polyether block amide (e.g., Arkema's Pebax nylons), any suitable polyvinyl chloride (“PVC”), and any suitable combination thereof. As mentioned, base material 203b of second extruder subsystem 201b may similarly be any suitable material, which may be the same as, slightly different than, or totally different than base material 203a. Such base material 203a may be provided to extruder subsystem 200a via a hopper 210a for processing in any suitable form including, for example, in liquid or solid form (e.g., pellets or chips of base material 203a can be provided within hopper 210a). A feedthroat of hopper 210a may control the passing of base material 203a from hopper 210a into a cavity 221a of a barrel 220a for processing. A screw 222a or any other suitable mechanism can be positioned within cavity 221a of barrel 220a and may be configured to rotate or otherwise move within cavity 221a (e.g., at the direction of a drive motor 228a) to direct base material 203a from a hopper end 224a of barrel 220a to a die end 226a of barrel 220a (e.g., in the direction of arrow 211a). Drive motor 228a can drive screw 222a at any suitable rate, speed, and/or any other suitable movement characteristic, including a variable speed.

Extruder subsystem 200a may be provided with one or more thermal components 214a along one or more portions of barrel 220a. Each thermal component 214a may be configured to heat barrel 220a to any desired melt temperature, which may melt at least a portion of base material 203a passing through cavity 221a. For example, barrel 220a can be heated to a temperature in the range of 200° Celsius to 300° Celsius (e.g., 250° Celsius), although the particular temperature can be selected based on each base material 203a used. As base material 203a passes through cavity 221a of barrel 220a, pressure and friction created by screw 222a and/or heat applied to barrel 220a by thermal component 214a can cause material 203a to melt and flow. The resulting material 203a can be substantially liquid in a region near die end 226a of barrel 220a so that it may easily flow into die 250 (e.g., via a screen subassembly 230a and/or via a feedpipe 240a of first extruder subsystem 201a). In some embodiments, different amounts of heat can be applied to different sections of barrel 220a to create a variable heat profile. For example, the amount of heat provided to barrel 220a can increase from hopper end 224a to die end 226a. By gradually increasing the temperature of barrel 220a from hopper end 224a to die end 226a, base material 203a deposited in cavity 221a of barrel 220a can gradually heat up and melt as it is pushed toward die end 226a in the direction of arrow 211a. This may reduce the risk of overheating, which may cause base material 203a to degrade. In some embodiments, one or more thermal components 214a of extruder subsystem 200a may be configured to cool barrel 220a for controlling a temperature profile of barrel 220a. For example, thermal component 214a may include a heating component (e.g., electrical heaters) and a cooling component (e.g., a fan). Each thermal component 214a may be configured to operate differently at different locations along barrel 220a (e.g., to heat barrel 220a at one or more locations, and to cool barrel 220a at one or more different locations). Any number of thermal components 214a can be provided along barrel 220a and/or along any other portion of subsystem 200a (e.g., along a portion of feedpipe 240a and/or die 250 and/or treatment module 260 (not shown)).

Screw 222a can have any suitable channel depth and/or screw angle for directing material within cavity 221a towards die 250. In some embodiments, screw 222a can define several zones, each of which may be designed to have different effects on the material within cavity 221a. For example, screw 222a can include a feed zone adjacent to hopper 210a that may be operative to carry solid material pellets of base material 203a to an adjacent melting zone where the solid material may melt. The channel depth of screw 222a can progressively increase in such a melting zone. Following such a melting zone, a metering zone can be used to melt the last particles of the material and mix the material to a uniform temperature and composition. In some embodiments, screw 222a can also include a decompression zone in which the channel depth may increase to relieve pressure within the screw and allow trapped gases (e.g., moisture or air) to be drawn out of cavity 221a (e.g., by a vacuum 215a). In such embodiments, screw 222a may also include a second metering zone having a lower channel depth to re-pressurize the fluid material 203a and direct it further towards die 250 in the direction of arrow 211a (e.g., at a constant and predictable rate).

When fluid material 203a reaches die end 226a of barrel 220a, material 203a can be expelled from barrel 220a and can pass through screen subassembly 230a, which may include one or more screens, each of which may include one or more openings that may be sized to allow material 203a to flow therethrough (e.g., in the direction of arrow 211a) but that may also be sized to prevent contaminants from passing therethrough. Screen subassembly 230a can be reinforced by a breaker plate that may be used to resist the pressure of material 203a as it is pushed towards die 250 by screw 222a. In some embodiments, screen subassembly 230a, with or without such a breaker plate, may be configured to provide back pressure to barrel 220a so that material 203a can melt and mix uniformly within cavity 221a of barrel 220a. The amount of pressure provided can be adjusted by changing the number of screens of screen subassembly 230a, by changing the relative positions of the screens of screen subassembly 230a (e.g., through mis-aligning openings in stacked screens), by changing the size of openings in each screen of screen subassembly 230a, and/or by changing any other suitable characteristic of screen subassembly 230a.

Material 203a passing through screen subassembly 230a may be directed through feedpipe 240a towards die 250. Feedpipe 240a can define an elongated feedpipe volume 241a through which material 203a can flow. Unlike within cavity 221a of barrel 220a, in which material 203a may rotate, material 203a passing through feedpipe volume 241a of feedpipe 240a can travel along feedpipe 240a with little or no rotation. This can ensure that when material 203a reaches die 250, there may be no built-in rotational stresses or strains that may adversely affect the resulting cable structure (e.g., stresses that may cause warping upon cooling).

Fluid material 203a passing through volume 241a of feedpipe 240a can reach die 250, where material 203a may be given an initial profile, which may or may not correspond to the final profile of the cover of the cable structure (e.g., cover 303 of cable structure 116). Material 203a can pass from volume 241a of feedpipe 240a of first extruder subsystem 201a into at least one die opening 251a of die 250 and around at least one pin portion 253 of die 250 that may be positioned about, around, and/or within die opening 251a. Each one of die 250, die opening 251a, and any die pin portion 253 forming a geometry of die 250 can have any suitable shape including, for example, a circular shape, curved shape, polygonal shape, or any arbitrary shape. In some embodiments, at least one pin portion can be movable within opening 251a of die 250, for example, such that the size or shape of at least one die opening 251a can be varied (e.g., during the extrusion process for a particular cable structure). Such movement of elements within die 250 may be controllable for adjusting a characteristic of the material passed out of die opening 251a (i.e., in the direction of arrow 213), such as a cross-sectional geometry.

In some embodiments, as shown, hypodermal path 252 may be provided to extend through die 250 (e.g., through a portion of die pin 253) or any other suitable element of system 200, such that a conductor arrangement 102 may be fed through the hypodermal path (e.g., in the direction of arrow 213) and through die 250. As a conductor arrangement 102 is fed through such a hypodermal path 252, material 203a flowing from feedpipe volume 241a of feedpipe 240a through die opening 251a may surround the conductor arrangement 102 as it exits hypodermal path 252 (e.g., material 203a may form at least a portion of cover 303 that may surround conductor arrangement 102 of left cable structure 116 of FIGS. 3 and 3A). Similarly, as mentioned above, as a conductor arrangement 102 is fed through such a hypodermal path 252, material 203b flowing from feedpipe volume 241b of feedpipe 240b through die opening 251b may surround the conductor arrangement 102 as it exits hypodermal path 252 (e.g., material 203b may form at least a portion of cover 303 that may surround conductor arrangement 102 of left cable structure 116 of FIGS. 3 and 3A). In such embodiments, as shown, for example, in FIGS. 3 and 3A, die 250 may be configured such that first material 203a, second material 203b, and conductor arrangement 102 may all be expelled from die 250 at the same time, such that first extruded material 203a may be at least partially exterior to (e.g., annular about) second extruded material 203b and such that second extruded material 203b may be exterior to (e.g., annular about) conductor arrangement 102 in a cross-section of a cover. In some alternative embodiments, a rod may instead be fed through such a hypodermal path and material 203a flowing from feedpipe 240a may instead be extruded around such a rod by die 250. Such a rod can have any suitable dimensions including, for example, a constant or variable cross-section, and may be coated or treated so that it may minimally adhere to the extruded material. Such a rod can be removed from the resulting structure formed by the extrusion process to form a hollow tube through which a conductor arrangement can then be fed.

To ensure that an external surface of the cover of the cable structure created using an extrusion process of extruder system 200 may be smooth and/or that the material may be uniformly distributed around a conductor arrangement, conductor arrangement 102 may be covered or surrounded along its length by a sheath (not shown) that may maintain a constant fixed and/or smooth outer diameter (e.g., diameter dn of conductor arrangement 102 of FIGS. 3 and 3A). Thus, while the outer diameter dn of conductor arrangement 102 may remain constant and/or smooth (e.g., along the length of left cable structure 116 of FIGS. 3 and 3A), the diameter of the extruded cover about conductor arrangement 102 can vary (e.g., as described below with respect to cover 503 of FIGS. 5 and 5A). Otherwise, in the absence of a smooth outer surface of conductor arrangement 102, material of a cover extruded over such a conductor arrangement may mirror or mimic discontinuities of the outer surface of the conductor arrangement. For example, if the conductor arrangement includes two distinct conductors placed length-wise side by side (e.g., parallel to one another and axis A), the outer surface of the extruded cover may include at least one indentation or discontinuity that reflects the separation between the conductors of such a conductor arrangement.

In any event, once material 203a and/or material 203b has passed through die 250, with or without a rod or conductor arrangement 102, the resulting structure (e.g., extrudate) may be fed into a treatment volume 261 of at least one treatment module 260 of system 200, which may be configured to thermally treat, pressure treat, and/or treat in any other suitable way at least a portion of the extruded material provided by die 250. For example, at least a portion of the extruded material provided by die 250 may be cooled within treatment volume 261 using any suitable approach, such as, for example, via a liquid bath (e.g., a water bath), air cooling, vacuum cooling, or combinations of these. As another example, at least a portion of the extruded material provided by die 250 may pressurized or de-pressurized within treatment volume 261 (e.g., using a vacuum treatment module 260). Treatment module 260 may be configured to provide the extruded material with its final profile, which may be the profile of the cover of the cable structure.

In some embodiments, one or more additives can be added to base material 203a and/or to base material 203b within any suitable processing space of system 200 to provide mechanical or finishing attributes to the cover of the cable structure. For example, one or more additives for providing any suitable attribute, such as for providing ultra-violet (“UV”) protection, adding flame-retardant grade materials, modifying a coefficient of friction of an outer surface of the cover, refining a color of the cable structure, or combinations of these, may be used. The additives can be provided in hopper 210a along with base material 203a and/or hopper 210b along with base material 203b. Additionally or alternatively, such additives may be inserted into cavity 221a of barrel 220a at another position along the length of barrel 220a between hopper end 224a and die end 226a. Additionally or alternatively, such additives may be inserted into feedpipe volume 241a of feedpipe 240a, into die opening 251a of die 250, and/or into treatment volume 261 of treatment module 260. The amount of any additives that may be added and the particular position at which any additives may be added can be selected based on any attributes of base material 203a. For example, additives can be added when base material 203a reaches a particular fluidity to ensure that the additives can mix with base material 203a.

Various system factors relating to the extrusion process of extruder system 200 can be adjusted to change one or more characteristics of the created structure (e.g., for generating a strain relief region and/or altering one or more of its characteristics). As mentioned, movement of pin 253 within die opening 251a and/or die opening 251b of die 250 during an extrusion process may alter the size and/or shape of the created cable structure cover by material 203a and/or material 203b. As another example, the speed at which a rod or conductor arrangement 102 may be passed through die 250 can be adjusted by line controller 270 to change the diameter (e.g., cross-sectional thickness) of the resulting structure extruded thereabout (e.g., the faster the line speed of the rod or conductor arrangement 102, the smaller the diameter of the resulting extruded cover of the cable structure thereabout). As another example, the speed at which screw 222a may bring material 203a to die 250 can be adjusted to control the amount of material 203a passing through die 250 in a particular period of time (e.g., the rotational speed of screw 222a may be adjusted via motor 228a). As yet another example, the amount of heat provided to barrel 221a (e.g., via thermal component 214a) may control the viscosity of material 203a within cavity 221a of barrel 220a and/or the pressure within cavity 221a of barrel 220a. As still another example, the melt pressure of material 203a within cavity 221a of barrel 220a can be adjusted. As still yet another example, characteristics of treatment module 260 may be adjusted to control one or more reactions within the extruded structure. As still yet another example, one or more screens and/or breaker plates of screen subassembly 230a can be adjusted to control the amount of material 203a passing from barrel 220a to die 250. As more material 203a passes through die 250 in a particular amount of time, the diameter of a resulting structure may be increased. As still yet another example, one or more material characteristics of the particular base materials 203a and 203b provided within the cable structure may be adjusted to control the material composition of the cable structure along various portions of its length. Additionally or alternatively, one or more relative ratios of one or more characteristics between the particular base material 203a provided within the cable structure through die 250 by first extruder subsystem 201a and the particular base material 203b provided within the cable structure through die 250 by second extruder subsystem 201b may be adjusted to control the material composition of the cable structure along various portions of its length. Specific settings for any one or more of these exemplary system factors of extruder system 200 can be dynamically adjusted during the extrusion process to change one or more characteristics of the created structure (e.g., for generating a localized strain relief region and/or altering one or more of its characteristics). Any one or more of these system factors can be adjusted by any suitable component of extruder system 200, such as, for example, by a control station 280 of system 200 that may be electrically coupled to and control one or more of the other components of system 200 (e.g., one or more of hopper 210a/210b, vacuum 215a/215b, thermal component 214a/214b, motor 228a/228b, screen subassembly 230a/230b, feedpipe 240a/240b, die 250, treatment module 260, line controller 270, and the like) via one or more data and/or power buses 281.

In particular, by dynamically adjusting one or more system factors, extruder system 200 can create a cable structure that may include at least one localized strain relief region along a portion of a length of a cover of the cable structure (e.g., strain relief region 301 along a portion of cover 303 of left cable structure 116 of FIGS. 1, 3, and 3A), where a transition change between the strain relief region and a non-strain relief region of the cover of the cable structure may be smooth and/or seamless. For example, the transition between a strain relief region and a non-strain relief region of a cover (e.g., from strain relief region 301 between points P1 and P5 of cover 303 of left cable structure 116 to the remaining region of cover 303 of left cable structure 116 beyond point P5 of FIGS. 1, 3, and 3A) may be visually unidentifiable to a user. In some embodiments, one or both of the amount of a characteristic of base material 203a and the amount of a characteristic of base material 203b provided in a certain portion of a cable structure cover may be varied over the length of the cover (e.g., may be varied amongst adjacent cross-sections of the cover along axis A, such as the cross-section of FIG. 3A that may be perpendicular to the extrusion process direction for the structure (e.g., the direction of arrow 213 of FIG. 2)), thereby changing a relationship between base material 203a and base material 203b along the length of the cover. For example, as shown in FIGS. 3 and 3A, the amount of a characteristic (e.g., cross-sectional thickness) of base material 203a extruded through die opening 251a of die 250 at any moment in time may be inversely proportional throughout the length of cover 303 with respect to that characteristic of base material 203b extruded through die opening 251b of die 250 such that the overall cross-sectional thickness of cover 303 of left cable structure 116 (e.g., dv) may be a constant along the length of at least strain relief region 301 of left cable structure 116 (e.g., such that the overall cross-sectional thickness of strain relief region 301 (e.g., dt) may be a constant).

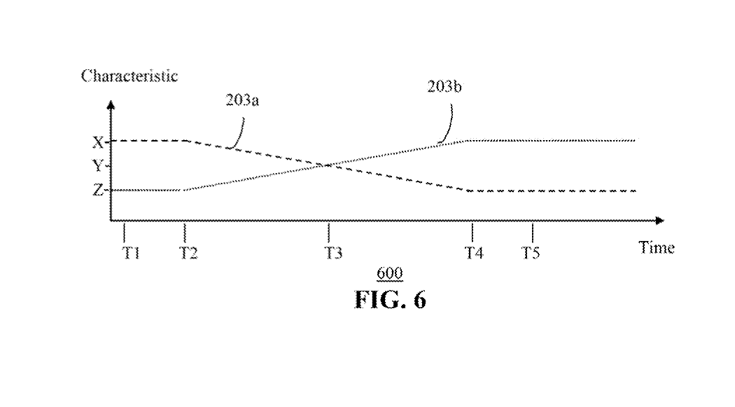

As shown by graph 600 of FIG. 6, for example, the amount of a characteristic (e.g., cross-sectional thickness) of first base material 203a provided through die 250 between times T1 and T2 (e.g., for generating a portion of a cover between points P1 and P2) may be at a relatively high amount X, may then decrease from relatively high amount X to a relatively low amount Z between times T2 and T4 (e.g., for generating a portion of a cover between points P2 and P4), and may then remain at relatively low amount Z between times T4 and 15 as well as after time T5 (e.g., for generating the remaining portion of the cover beyond point P4). Moreover, as also shown by graph 600 of FIG. 6, for example, the amount of a characteristic (e.g., cross-sectional thickness) of second base material 203b provided through die 250 between times T1 and T2 (e.g., for generating a portion of a cover between points P1 and P2) may be at the relatively low amount Z, may then increase from relatively low amount Z to relatively high amount X between times T2 and T4 (e.g., for generating a portion of a cover between points P2 and P4), and may then remain at relatively high amount X between times T4 and T5 as well as after time T5 (e.g., for generating the remaining portion of the cover beyond point P4).

In some embodiments, this combination of amounts of first base material 203a and second base material 203b may combine in system 200 to generate at least strain relief region 301 of cover 303 of left cable structure 116 of FIGS. 1, 3, and 3A, where first base material 203a may have a different property (e.g., different elastic modulus, stiffness, durometer, hardness, flexibility, etc.) than second base material 203b, such that the varying cross-sectional thickness of each material forming a particular portion of a cross-section of strain relief region 301 of cover 303 between points P1 and P5 along the length of left cable structure 116 may vary the stiffness of strain relief region 301 between points P1 and P5. For example, first base material 203a may be stiffer than second base material 203b, such that the portion of strain relief region 301 between points P1 and P2 may be stiffer than the portion of strain relief region 301 between points P4 and P5, while the portion of strain relief region 301 between points P2 and P4 may transition between the higher stiffness at point P2 to the lower stiffness at point P4. That is, the portion of strain relief region 301 adjacent an end of left cable structure 116 coupled to left speaker 130 between points P1 and P2, where there may be a greater cross-sectional thickness of stiffer first material 203a (e.g., thickness da1 of FIG. 3 or thickness X of FIG. 6) than cross-sectional thickness of less stiff second material 203b (e.g., thickness db1 of FIG. 3 or thickness Z of FIG. 6), may be stiffer than the portion of strain relief region 301 distanced from the end of left cable structure 116 coupled to left speaker 130 between points P4 and P5, where there may be a greater cross-sectional thickness of less stiff second material 203b (e.g., thickness db5 of FIG. 3 or thickness X of FIG. 6) than cross-sectional thickness of more stiff first material 203a (e.g., thickness da5 of FIG. 3 or thickness Z of FIG. 6). In such embodiments, relatively high cross-sectional thickness X and relatively low cross-sectional thickness Z may be any suitable values that may provide a variable stiffness cover 303 along at least a portion of the length of stress relief region 301. For example, cross-sectional thickness X may be 5-100 times the magnitude of cross-sectional thickness Z. In other embodiments, cross-sectional thickness X may be 10 times the magnitude of cross-sectional thickness Z.

First material 203a extruded through die 250 for forming at least a portion of cover 303 may differ in any suitable way from second material 203b extruded through die 250 for forming at least a portion of cover 303 such that the variance between the two materials may vary the stiffness of cover 303 along strain relief region 301. For example, a first material 203a may be stiffer than a second material 203b due to any suitable conditions. For example, a less stiff second material 203b may have about 25%-50% of the stiffness of a stiffer first material 203a. In some embodiment, a stiffer first material may be about 100 megapascals and a less stiff second material may be about 25-50 megapascals. In some embodiments, both the stiffer first material 203a and the less stiff second material 203b may be similar materials (e.g., the same TPU or the same TPE) but with an adjusted stiffness due to any suitable technique. An interface 204 between first material 203a and second material 203b (see, e.g., FIGS. 3 and 3A) may include any suitable bonding between at least a portion of the interfacing materials.

Therefore, a manufacturing process of system 200 may enable creation of a single continuous cable structure (e.g., through extrusion) that may include at least one strain relief region (e.g., a region with at least a first localized region at a first cross-section (e.g., at point P1) that may be stiffer than a second localized region at a second cross-section (e.g., at point P4)). Such a cover with such a strain relief region may be a single, smooth, and/or continuous extruded cover, rather than multiple distinct extruded portions coupled together. Such a strain relief region may be used as a strain relief for a cable structure, thereby obviating the need for any additional manufacturing processes that may add an additional strain relief component on top of or adjacent an end of the cable structure. For example, such a strain relief may obviate the need for an additional molded part may be overmolded about core 303 that may often provide unwanted stiffness discontinuity and/or stress concentration, unwanted additional height of the cable structure (e.g., along the Y-axis and/or the Z-axis), and/or unwanted additional manufacturing steps and associated unwanted costs. Therefore, as compared to conventionally used strain relief overmolds, a strain relief region 301 that may be generated by system 200 may allow for smaller cable structures, improved reliability by eliminating stress concentrations by gradually transitioning from one material ratio to another, more discrete tuning of strain relief stiffness, reduced manufacturing steps/costs, and/or higher manufacturing yields. Such a manufacturing process of system 200 for dynamically varying the stiffness of a single cable cover during extrusion of the cable cover about a conductor arrangement may create a strain relief region without altering the overall shape or size of the cable structure. For example, a strain relief region itself as well as the transition between the strain relief region and a non-strain relief region of a cover (e.g., from strain relief region 301 between points P1 and P5 of cover 303 of left cable structure 116 to the remaining region of cover 303 of left cable structure 116 beyond point P5 of FIGS. 1, 3, and 3A) may be visually unidentifiable to a user with respect to size, feel, and/or color. For example, as shown in FIG. 3, the outer cross-sectional thickness of cable structure 116 between points P1 and P5 as well as beyond point P5 may be a constant dt, while the outermost material of cover 303 of cable structure 116 between points P1 and P5 as well as beyond point P5 may always be first material 203a, such that the outer appearance of cover 303 may be consistent along its length (e.g., at least along the length of strain relief region 301). Alternatively or additionally, although not shown, a third material (e.g., via a third extrusion subsystem 201 of system 200) may be extruded through die 250 (e.g., through a third die opening exterior to die opening 251a) for providing a cosmetic outer layer for a cover to maintain a consistent exterior appearance for the cover along the length of the cable structure.

As shown in FIG. 6, the transition of first material 203a from amount X at time T2 to amount Z at time T4 may be linear and inversely proportional to the amount of second material 203b of the transition from amount Z at time T2 to amount X at time T4 (e.g., such that both first material 203a and second material 203b may have the same median amount Y between amounts X and Z at median time T3 between times T2 and T4 (e.g., where thickness da3 and thickness db3 of FIG. 3 may be equal at point P3 halfway between points P2 and P4). Alternatively, the shape of material 203a's transition and/or the shape of material 203b's transition amongst various characteristic amounts of graph 600 may be any suitable shape (e.g., curved, stepped, sinusoidal, etc.), such that the combination of varied characteristics of each one of material 203a and 203b through die 250 may create the desired cover with a functional strain relief region. The characteristic of graph 600 may be any suitable characteristic, such as cross-sectional thickness, mass, density, temperature, or any other suitable characteristic.

It is to be understood that references to a “stiffer” portion of a strain relief region (e.g., the portion of strain relief region 301 between points P1 and P2) may be any suitable portion that may include a cross-section with a larger bend radius or stiffer attribute than another adjacent portion of the strain relief region (e.g., the portion of strain relief region 301 between points P4 and P5). In some embodiments, a stiffer portion may include only a stiffer material 203a and none of a less stiff material 203b, while the less stiff portion may include only less stiff material 203b and none of stiffer material 203a. Alternatively, as shown in FIGS. 3 and 3A, at least a minimum cross-sectional thickness (e.g., thickness Z of FIG. 6 and/or thicknesses db1/da5 of FIG. 3) of each one of material 203a and 203b may exist at each cross-section of cover 303 along the length of cable structure 116. As mentioned, this may allow for an outermost portion of cover 303 to always be provided by a certain material (e.g., material 203a). While material 203a has been mentioned as being stiffer than material 203b and while material 203a has been shown to be extruded on the exterior of material 203b (e.g., die opening 251a may be outside of die opening 251b), it is to be understood that the less stiff material may be extruded on the exterior of the stiffer material (e.g., the relative positions of stiffer material 203a and less stiff material 203b may be flipped with respect to the configuration of FIG. 3). Additionally or alternatively, while material 203a has been mentioned as being stiffer than material 203b, the opposite may be true. In such cases, the shape of material 203a's transition and/or the shape of material 203b's transition amongst various characteristic amounts of graph 600 may be inverted, such that more of the stiffer material 203b may be provided between points P1 and P2 than between points P4 and P5 for providing an adequate strain relief.

In some embodiments, rather than a strain relief region including two distinct materials simultaneously extruded through two distinct die openings (e.g., material 203a through die opening 251a and material 203b through die opening 251b), a strain relief region with a variable stiffness may include a single mixture of two or more materials extruded through a single die opening. For example, as shown in FIG. 2A, a system 200′ may be used for conducting an extrusion process through which a single mixture 203m of two or more distinct materials (e.g., first base material 203a and second base material 203b) may be generated in a manifold 290 and then extruded through a single die opening 251 about conductor arrangement 102. For example, system 200′ of FIG. 2A may be similar to system 200 of FIG. 2, but rather than passing first material 203a from volume 241a of feedpipe 240a of first extruder subsystem 201a into at least first die opening 251a of die 250 and passing second material 203b from volume 241b of feedpipe 240b of second extruder subsystem 201b into second die opening 251b of die 250, system 200′ may pass both first material 203a from volume 241a of feedpipe 240a of first extruder subsystem 201a and second material 203b from volume 241b of feedpipe 240b of second extruder subsystem 201b into the same volume 291 of manifold 290 or any other suitable component that may be configured to receive two or more different materials and then to pass a suitable mixture of the two or more received materials as a single mixture 203m from volume 291 into at least one die opening 251 of die 250′. Die 250′ of system 200′ may be similar to die 250 of system 200, but die 250′ may include only a single extrudable cover material opening 251 about conductor pathway 252 rather than at least two die openings 251a and 251b of die 250 about conductor pathway 252. As shown in FIG. 2A, Manifold 290 may include a first input valve 291a that may be configured to regulate the flow of first material 203a from volume 241a of feedpipe 240a of first extruder subsystem 201a into manifold volume 291, a second input valve 291b that may be configured to regulate the flow of second material 203b from volume 241b of feedpipe 240b of second extruder subsystem 201b into manifold volume 291, and/or a first output valve 293 that may be configured to regulate the flow of material mixture 203m from manifold volume 291 into die opening 251 of die 250′. Any, some, or each one of manifold valves 291a, 291b, and/or 293 may be any suitable valve, such as a solenoid valve, and may be controlled by controller 280 in any suitable way for regulating one or more suitable characteristics of the one or more materials entering and/or leaving manifold 290.

As shown in FIGS. 1, 4, and 4A, for example, system 200′ may be used to generate cover 403 along at least a portion of the length of main cable structure 112, whereby cover 403 may be formed by extrusion of material mixture 203m from die opening 252 of die 250′ about conductor arrangement 102. In particular, by dynamically adjusting one or more system factors of subsystem 201a, subsystem 201b, manifold 290, line control 270, and/or die 250′, extruder system 200′ can create a cable structure that may include at least one localized strain relief region along a portion of a length of a cover of the cable structure (e.g., strain relief region 401 along a portion of cover 403 of main cable structure 112 of FIGS. 1, 4, and 4A), where a transition change between the strain relief region and a non-strain relief region of the cover of the cable structure may be smooth and/or seamless. For example, the transition between a strain relief region and a non-strain relief region of cover 403 from strain relief region 401 between points P1 and P5 of cover 403 of main cable structure 112 to the remaining region of cover 403 of main cable structure 112 beyond point P5 of FIGS. 1, 4, and 4A may be visually unidentifiable to a user. In some embodiments, one or both of the amount of a characteristic of base material 203a and the amount of a characteristic of base material 203b provided in a certain portion of a cable structure cover may be varied over the length of the cover (e.g., may be varied amongst adjacent cross-sections of the cover along axis A, such as the cross-section of FIG. 4A that may be perpendicular to the extrusion process direction for the structure (e.g., the direction of arrow 213 of FIG. 2A)), thereby changing a relationship between base material 203a and base material 203b (e.g., in material mixture 203m) along the length of cover 403. For example, as shown in FIGS. 4 and 4A, the amount of a characteristic of first base material 203a with respect to material mixture 203m (e.g., percentage of material mixture 203m defined by first base material 203a) extruded through die opening 251 of die 250′ at any moment in time may be inversely proportional throughout the length of cover 403 with respect to that characteristic of second base material 203b with respect to material mixture 203m (e.g., percentage of material mixture 203m defined by second base material 203b) extruded through die opening 251 of die 250′ such that the overall cross-sectional thickness of cover 403 of main cable structure 112 (e.g., dv) may be a constant along the length of at least strain relief region 401 of main cable structure 112 (e.g., such that the overall cross-sectional thickness of strain relief region 401 (e.g., dt) may be a constant).

As shown by graph 600 of FIG. 6, for example, the amount of a characteristic (e.g., percentage of material mixture 203m) of first base material 203a with respect to material mixture 203m (e.g., percentage of material mixture 203m defined by first base material 203a) provided through die 250′ of system 200′ between times T1 and T2 (e.g., for generating a portion of a cover between points P1 and P2) may be at a relatively high amount X, may then decrease from relatively high amount X to a relatively low amount Z between times T2 and T4 (e.g., for generating a portion of a cover between points P2 and P4), and may then remain at relatively low amount Z between times T4 and T5 as well as after time T5 (e.g., for generating the remaining portion of the cover beyond point P4). Moreover, as also shown by graph 600 of FIG. 6, for example, the amount of a characteristic of second base material 203b with respect to material mixture 203m (e.g., percentage of material mixture 203m defined by second base material 203b) provided through die 250′ of system 200′ between times T1 and T2 (e.g., for generating a portion of a cover between points P1 and P2) may be at the relatively low amount Z, may then increase from relatively low amount Z to relatively high amount X between times T2 and T4 (e.g., for generating a portion of a cover between points P2 and P4), and may then remain at relatively high amount X between times T4 and T5 as well as after time T5 (e.g., for generating the remaining portion of the cover beyond point P4).

In some embodiments, this variation of percentage of material mixture 203m defined by first base material 203a and second base material 203b may combine in system 200′ to generate at least strain relief region 401 of cover 403 of main cable structure 112 of FIGS. 1, 4, and 4A, where first base material 203a may have a different property (e.g., different elastic modulus, stiffness, durometer, hardness, flexibility, etc.) than second base material 203b, such that the varying percentage makeup of material mixture 203m by each base material 203a/203b forming a particular cross-section of strain relief region 401 of cover 403 between points P1 and P5 along the length of main cable structure 112 may vary the stiffness of strain relief region 401 between points P1 and P5. For example, first base material 203a may be stiffer than second base material 203b, such that the portion of strain relief region 401 between points P1 and P2 may be stiffer than the portion of strain relief region 401 between points P4 and P5, while the portion of strain relief region 401 between points P2 and P4 may transition between the higher stiffness at point P2 to the lower stiffness at point P4. That is, the portion of strain relief region 401 adjacent an end of main cable structure 112 coupled to audio connector 120 between points P1 and P2, where material mixture 203m may include a greater percentage of stiffer first material 203a (e.g., relatively higher percentage X of FIG. 6 (e.g., as may be indicated by more dense hatching of FIG. 3)) than percentage of less stiff second material 203b (e.g., relatively lower percentage Z of FIG. 6), may be stiffer than the portion of strain relief region 401 distanced from the end of main cable structure 112 coupled to audio connector 120 between points P4 and P5, where material mixture 203m may include a greater percentage of less stiff second material 203b (e.g., relatively higher percentage X of FIG. 6) than percentage of more stiff first material 203a (e.g., relatively lower percentage Z of FIG. 6 (e.g., as may be indicated by less dense hatching of FIG. 3)). Relatively higher percentage X and relatively lower percentage Z may be any suitable values or may have any suitable relationship that may provide a variable stiffness to material mixture 203m along at least a portion of the length of stress relief region 401. For example, percentage X may be 100% and percentage Z may be 0%. In other embodiments, percentage X may be 90% and percentage Z may be 10%, such that at least a portion of material mixture at each point along cover 403 may include at least 10% of each base material.

The portion of material mixture 203m defined by first material 203a extruded through die 250′ for forming at least a portion of cover 403 may differ in any suitable way from the portion of material mixture 203m defined by second material 203b extruded through die 250′ for forming at least a portion of cover 403 such that the variance between the two materials may vary the stiffness of cover 403 along strain relief region 401. For example, a first material 203a may be stiffer than a second material 203b due to any suitable conditions. For example, a less stiff second material 203b may have about 25%-50% of the stiffness of a stiffer first material 203a. In some embodiment, a stiffer first material may be about 100 megapascals and a less stiff second material may be about 25-50 megapascals. In some embodiments, both the stiffer first material 203a and the less stiff second material 203b may be similar materials (e.g., the same TPU or the same TPE) but with an adjusted stiffness due to any suitable technique.

Therefore, a manufacturing process of system 200′ may enable creation of a cable structure (e.g., through extrusion) that may include at least one strain relief region (e.g., a region with at least a first localized region at a first cross-section (e.g., at point P1) that may be stiffer than a second localized region at a second cross-section (e.g., at point P4)). Such a strain relief region may be used as a strain relief for a cable structure, thereby obviating the need for any additional manufacturing processes that may add an additional strain relief component on top of or adjacent an end of the cable structure (e.g., as an additional molded part that may often provide stiffness discontinuity and/or stress concentration). Moreover, such a manufacturing process of system 200′ may create a strain relief region without altering the overall shape or size of the cable structure. For example, a strain relief region itself as well as the transition between the strain relief region and a non-strain relief region of a cover (e.g., from strain relief region 401 between points P1 and P5 of cover 403 of main cable structure 113 to the remaining region of cover 403 of main cable structure 112 beyond point P5 of FIGS. 1, 4, and 4A) may be visually unidentifiable to a user with respect to size, feel, and/or color. For example, as shown in FIG. 4, the outer cross-sectional thickness of cable structure 112 between points P1 and P5 as well as beyond point P5 may be a constant dt, while the outermost material of cover 403 of cable structure 112 between points P1 and P5 as well as beyond point P5 may always be material mixture 203m, such that the outer appearance of cover 403 may be consistent along its length (e.g., at least along the length of strain relief region 401). In such embodiments, an additive, such as a coloring or coating, may be provided to material mixture 203m (e.g., in manifold 290), such that material mixture 203m may maintain a constant look and/or feel along the length of cover 401 despite having a variable concentration or percentage of material 203a with respect to material 203b. Alternatively or additionally, although not shown, a third material (e.g., via a third extrusion subsystem 201 of system 200) may be extruded through die 250′ (e.g., through a die opening exterior to die opening 251) for providing a cosmetic outer layer for a cover to maintain a consistent exterior appearance for the cover along the length of the cable structure.

As shown in FIG. 6, the transition of first material 203a from percentage/concentration amount X at time T2 to amount Z at time T4 may be linear and inversely proportional to the amount of second material 203b of the transition from amount Z at time T2 to amount X at time T4 (e.g., such that both first material 203a and second material 203b may have the same median percentage/concentration amount Y between amounts X and Z at median time T3 between times T2 and T4. Alternatively, the shape of material 203a's transition and/or the shape of material 203b's transition amongst various characteristic amounts of graph 600 may be any suitable shape (e.g., curved, stepped, sinusoidal, etc.), such that the combination of varied characteristics of each one of material 203a and 203b through die 250′ may create the desired cover with a functional strain relief region. The characteristic of graph 600 may be any suitable characteristic, such as percentage/concentration amount, cross-sectional thickness, mass, density, temperature, or any other suitable characteristic. One or more of input valves 291a and 291b may be configured or otherwise controlled (e.g., by control station 280 of system 200′) to dictate the percentage/concentration of material mixture 203m for each of two or more base materials from two or more extruder subsystems 201 (e.g., base material 203a and base material 203b), where such mixture concentration may be varied during the extrusion process (e.g., over the length of at least a portion of cover 403 for defining strain relief region 401).

Alternatively or additionally, one or more of output valve 293 and line controller 270 may be configured or otherwise controlled (e.g., by control station 280 of system 200′) to dictate the thickness of material mixture 203m, which may be varied during the extrusion process (e.g., over the length of at least a portion of a cover for defining a strain relief region). For example, as mentioned, the thickness of strain relief region 401 of cover 403 of FIGS. 1, 4, and 4A may be a constant thickness (e.g., thickness dv between points P1 and P5 of FIG. 4 may be constant due to a constant amount of material mixture 203m being supplied by manifold 290 through die opening 251 of die 250′ over time and/or due to conductor arrangement 102 being fed through passageway 252 of die 250′ by line controller 270 at a constant rate). Alternatively, in some other embodiments, as shown in FIGS. 1, 5, and 5A, the thickness of strain relief region 501 of cover 503 may be a varied over a portion of the length of right cable structure 118. For example, as shown in FIG. 5, the thickness of strain relief portion 501 of cover 503 may be a first thickness d1v at first point P1 adjacent right speaker 140 (e.g., to match overall thickness d1t of cable structure 118 and right speaker 140 at a shared point P1, such as for aesthetic reasons) and may gradually be reduced to a second thickness dv at second point P2 and beyond to at least point P5. Such a gradual reduction in thickness of cover 503 may be controlled by a gradual increase in the speed with which line controller 270 may feed conductor arrangement 102 through die 250′ during the extrusion of cover 503 and/or by a gradual decrease in the amount of material mixture 203m that may be fed by manifold 290 through die 250′ during the extrusion of cover 503. One or more melt pumps may be provided at any suitable position or positions along one or more of system 200 or system 200′, where each melt pump may be configured to vary cable outer diameter by speeding up or slowing down material provided through one or more portions of system 200/200′ (e.g., to vary outer diameter of region 301 and/or region 401).

Such a thickness changing transition of a portion of a strain relief region of a cable structure cover may take any suitable shape, such as any suitable shape that may exhibit a fluid or smooth transition. For example, the shape of the transition can be similar to that of a cone or a neck of a wine bottle. As another example, the shape of the transition can be stepless (i.e., there may be no abrupt or dramatic step change in diameter, or no sharp angle at an end of the transition). In some embodiments, the transition may be mathematically represented by a bump function, which may require the entire changing transition to be stepless and smooth (e.g., the bump function may be continuously differentiable). A portion of a strain relief region with the same material mixture 203m (e.g., the same concentration of various materials 203a/203b) but an increased thickness may provide increased strain relief due to the extra girth provided. Moreover, such a larger dimension of cover 503 (e.g., thickness d1v at point P1) compared to another portion of cover 503 (e.g., thickness dv at points P2-P5) may enable a more secure connection (e.g., via an adhesive or any other suitable connection mechanism) between that cover 503 and an adjacent component (e.g., speaker 140) due to an increased contact area therebetween (e.g., at point P1). For example, as shown in FIG. 5, the connection between right speaker 140 and increased thickness d1v of cover 503 of right cable structure 118 may be more robust and more secure than if cover 503 did not include that increased thickness and instead right speaker 140 were connected to right cable structure 118 at reduced thickness dv of cover 503 (e.g., as compared to the reduced connection area between component 120 and cable structure 112 of FIG. 4 at reduced thickness dv of cover 403).

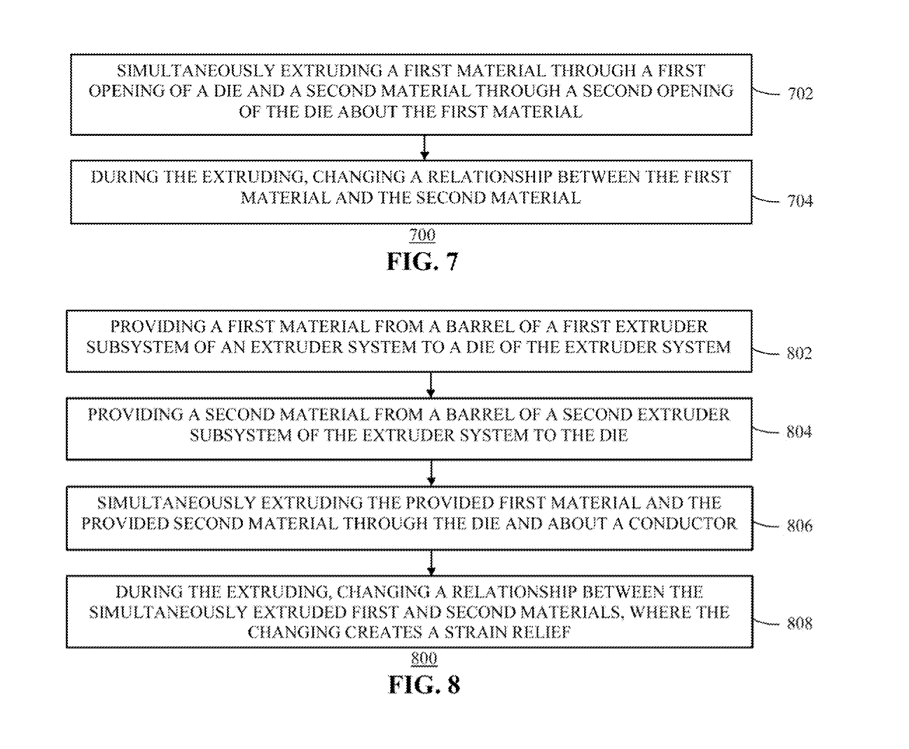

FIG. 7 is a flowchart of an illustrative process 700 for forming a cable structure. At step 702, process 700 may include simultaneously extruding a first material through a first opening of a die; and a second material through a second opening of the die about the first material. For example, as described with respect to FIGS. 2-3A, base material 203b may be extruded through die opening 251b of die 250 and base material 203a may be simultaneously extruded through die opening 251a of die 250 about base material 203b. At step 704, during the extruding of step 702, process 700 may include changing a relationship between the first material and the second material. For example, as described with respect to FIGS. 2-3A and 6, a relationship between the cross-sectional thickness of material 203a and the cross-sectional thickness of material 203b may be changed during the extrusion of cover 303 (e.g., from time T2 to time T4).

It is understood that the steps shown in process 700 of FIG. 7 are merely illustrative and that existing steps may be modified or omitted, additional steps may be added, and the order of certain steps may be altered.

FIG. 8 is a flowchart of an illustrative process 800 for forming a cable structure. At step 802, process 800 may include providing a first material from a barrel of a first extruder subsystem of an extruder system to a die of the extruder system. For example, as described with respect to FIGS. 2′, 4, 4A, and 6, first base material 203a may be provided from barrel 220a of first extruder subsystem 201a of extruder system 200′ to die 250′ of extruder system 200′ (e.g., via feedpipe 240a and manifold 290). At step 804, process 800 may include providing a second material from a barrel of a second extruder subsystem of the extruder system to the die. For example, as described with respect to FIGS. 2′, 4, 4A, and 6, second base material 203b may be provided from barrel 220b of second extruder subsystem 201b of extruder system 200′ to die 250′ of extruder system 200′ (e.g., via feedpipe 240b and manifold 290). Next, at step 806, process 800 may include simultaneously extruding the provided first material and the provided second material through the die and about a conductor. For example, as described with respect to FIGS. 2′, 4, 4A, and 6, first base material 203a and second base material 203b may be simultaneously extruded (e.g., as material mixture 203m) through die 250′ about conductor arrangement 102. At step 808, during the extruding of step 806, process 800 may include changing a relationship between the simultaneously extruded first and second materials, where the changing may create a strain relief for a cable structure. For example, as described with respect to FIGS. 2′, 4, 4A, and 6, a relationship between the percentage/concentration of first material 203a with respect to material mixture 203m and the percentage/concentration of second material 203b with respect to material mixture 203m may be changed during the extrusion of cover 403 (e.g., from time T2 to time T4), which may create strain relief region 401 of cable structure 112.

It is understood that the steps shown in process 800 of FIG. 8 are merely illustrative and that existing steps may be modified or omitted, additional steps may be added, and the order of certain steps may be altered.

While there have been described cable structures with multi-material extruded strain reliefs and systems and methods for making the same, it is to be understood that many changes may be made therein without departing from the spirit and scope of the invention. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “up and “down,” “front” and “back,” “top” and “bottom” and “side,” “length” and “width” and “thickness” and “diameter” and “cross-section” and “longitudinal,” “X-” and “Y-” and “Z-,” and the like may be used herein only for convenience, and that no fixed or absolute directional or orientational limitations are intended by the use of these words. For example, the cable structures of this invention can have any desired orientation. If reoriented, different directional or orientational terms may need to be used in their description, but that will not alter their fundamental nature as within the scope and spirit of this invention.

Therefore, those skilled in the art will appreciate that the invention can be practiced by other than the described embodiments, which are presented for purposes of illustration rather than of limitation.

What is claimed is:

1. A method for forming a cable structure, the method comprising:
simultaneously extruding:
a first material through a first opening of a die; and
a second material through a second opening of the die about the first material; and
during the extruding, changing a relationship between the first material and the second material.

2. The method of claim 1, wherein the changing creates a strain relief for the cable structure.

3. The method of claim 1, further comprising feeding a conductor arrangement through the die during the extruding.

4. The method of claim 3, wherein the extruding the first material comprises extruding the first material between the conductor arrangement and the second material.

5. The method of claim 1, wherein the relationship comprises a ratio of the amount of the first material to the amount of the second material simultaneously extruded.

6. The method of claim 5, wherein the changing varies a stiffness of the cable structure.

7. The method of claim 6, wherein the changing does not vary an outer diameter of the cable structure.

8. The method of claim 5, wherein the changing does not vary an outer diameter of the cable structure.

9. The method of claim 1, the first material is stiffer than the second material.

10. The method of claim 1, wherein the second material is stiffer than the first material.

11. A cable structure comprising:
a conductor arrangement extending along a length of the cable structure; and
a cover comprising:
a first cover material surrounding the conductor arrangement along the length of the cable structure; and
a second cover material surrounding the first cover material along the length of the cable structure, wherein a relationship between the first cover material and the second cover material varies along the length of the cable structure.

12. The cable structure of claim 11, wherein the relationship comprises a ratio of the amount of the first cover material to the amount of the second cover material provided by the cover.

13. The cable structure of claim 11, wherein the cover provides a strain relief for the cable structure along the length of the cable structure.

14. The cable structure of claim 11, wherein an outer diameter of the cover is constant along the length of the cable structure.

15. The cable structure of claim 11, wherein the first cover material is stiffer than the second cover material.

16. The cable structure of claim 11, wherein the second cover material is stiffer than the first cover material.

17. The cable structure of claim 11, wherein:
a first cross-section of the cover at a first point along the length of the cable structure comprises:
a first thickness of the first cover material surrounding the conductor arrangement; and
a second thickness of the second cover material surrounding the first thickness of the first cover material;
a second cross-section of the cover at a second point along the length of the cable structure comprises:
a third thickness of the first cover material surrounding the conductor arrangement; and
a fourth thickness of the second cover material surrounding the third thickness of the first cover material; and
a ratio of the first thickness to the second thickness is greater than a ratio of the third thickness to the fourth thickness.

18. The cable structure of claim 17, wherein the outer diameter of the first cross-section of the cover is the same as the outer diameter of the second cross-section of the cover.

19. The cable structure of claim 17, wherein the cover provides a strain relief for the cable structure along the length of the cable structure between the first point and the second point.

20. A method for forming a cable structure, the method comprising:
providing a first material from a barrel of a first extruder subsystem of an extruder system to a die of the extruder system;
providing a second material from a barrel of a second extruder subsystem of the extruder system to the die;
simultaneously extruding the provided first material and the provided second material through the die and about a conductor; and
during the extruding, changing a relationship between the simultaneously extruded first and second materials, wherein the changing creates a strain relief for the cable structure.

21. The method of claim 20, wherein the simultaneously extruding comprises:
extruding the provided first material through a first die opening of the die and about the conductor; and
extruding the provided second material through a second die opening of the die and about the first material.

22. The method of claim 21, wherein the relationship comprises a ratio of the amount of the first material to the amount of the second material simultaneously extruded.

23. The method of claim 20, wherein the simultaneously extruding comprises:
extruding a mixture of the provided first material and of the provided second material through a die opening of the die and about the conductor.

24. The method of claim 23, wherein the relationship comprises a ratio of the amount of the first material to the amount of the second material simultaneously extruded.
